(19) United States
(12) Patent Application Publication
(10) Pub. No.: US 2008/0261029 A1
(43) Pub. Date: Oct. 23, 2008

(54) Non-Stick Metal Product Coated by Pvd with a Hydrophobic Metal Oxide

(76) Inventor: Anna Andersson, Vasteras (SE)

Correspondence Address: Carter, DeLuca, Farrell & Schmidt, 445 Broad Hollow Road, Suite 225, Melville, NY, 11747, US

(21) Appl. No.: 11/885,173

(22) PCT Filed: Mar. 9, 2006
(86) PCT No.: PCT/SE06/00313

§ 371 Date: Aug. 24, 2007

(30) Foreign Application Priority Data
Mar. 11, 2005 (SE) 0500605-1

(51) Int. Cl. B32B 15/04; B32B 5/00

(52) U.S. Cl. 428/336; 428/469

(57) ABSTRACT

A non-stick product is described. It comprises a metal substrate (2), such as steel, with a hydrophobic oxide layer (1) having a substantially amorphous microstructure. The non-stick product is preferably produced by means of PVD. A suitable process to be used is electron beam evaporation (FE). It may be used in manufacturing processes for electrical components, such as capacitors or batteries, or as surfaces in contact with low temperature melting metals.

The present disclosure relates to a metal product for non-stick applications, such as in manufacturing processes for electrical components or as surfaces in contact with low-melting metals. More specifically it relates to a metal product consisting of a metal substrate with at least one coating layer. The coating layer consists of a hydrophobic metal oxide having an amorphous microstructure. Furthermore, it relates to a method of producing such a metal product.

### BACKGROUND

Non-stick products/materials are used in a number of different applications, for example, transporting belts inter alia for food processing such as baking, freeze dehydration, or the like. Another example is as supporting materials in industrial manufacturing processes such as base plates in furnaces of various kinds. Basically, all surfaces in industrial processes acting as contact surfaces, whether it is as supporting surfaces or as guiding surfaces, usually need to possess non-stick properties if for example an object to be manufactured should be able to be transferred to the next manufacturing step without problems. A non-stick surface may experience both low friction if the object to be manufactured should slip off or glide on the surface, and high friction if the object should be laying still while still not stick to the surface.

Generally, there are two different ways of solving the problem of providing a non-stick product. The first one is to form a thin closed water film on the surface. This solution is suitable at normal temperatures, i.e. around room temperature. The other solution is to provide a surface where liquids and other substances not are allowed to wet or react with the surface. This latter solution may be used both at low and high temperatures.

There are several types of non-stick products based on different types of materials, such as polymers, composites or ceramics. A common polymer non-stick material is polytetrafluoroethylene-based material (PFTE, also known as Teflon), which is disclosed for example in WO03/088796 A1 as a grilling surface. However, PTFE-based materials are relatively expensive to use, especially on a large scale objects. Furthermore, the lifetime of PTFE-based materials in industrial environments is fairly limited. Other examples of materials used for non-stick applications are Al₂O₃, TiO₂ and ZrO₂, which is disclosed for example in US 2004/253432. In this case the mentioned oxides are used due to their hydrophilic properties since a thin closed film of liquid is formed on the surface, whereby particles from the surrounding environment are slipping off the surface.

WO99/36193 discloses a method for providing a conductive, amorphous non-stick coating which may possess hydrophilic or hydrophobic properties. The coating could be used in various applications such as cooking containers, razor blades or medical devices. The substrate may be metallic and the coating can be for example titanium nitride, aluminum oxide or zirconium oxide. The coating is in these cases applied to the substrate by sputtering.

The non-stick property can be measured by utilization of the wetting angle (also called contact angle). The wetting angle is the tangent angle at the interface between a droplet of liquid and a solid surface. For a perfectly hydrophilic surface, the wetting angle is 0° (sometimes also referred to as superhydrophilic surface) and for a hydrophobic surface ≧90°. FIG. 3 illustrates a hydrophilic example with a droplet D on a surface having a wetting angle α and a hydrophobic example with another droplet D having a wetting angle β. The wetting angle may be determined at equilibrium by the Young equation:

$$Cos θ = \frac{{γ}_{sv} - {γ}_{sl}}{{γ}_{lv}}$$

Wherein θ is the wetting angle and γ represents the surface tension between the corresponding interfaces. Moreover, s stands for solid, v for vapor, and l for liquid. The wetting angle for PTFE with water is generally considered to be approximately 110°, graphite approximately 85°, whereas in the case of silicon approximately 50°.

In the present case, the goal is to develop a new type of non-stick products which could be used especially in industrial environments. Depending on the specific industrial application, the requirements of the non-stick product are generally high. In addition to the non-stick properties, the product should also have a long service life, be able to withstand even corrosive environments and operate at elevated temperatures such as above 200° C., as well as at lower temperatures. Also, the non-stick product often needs to have a high mechanical strength for example if subjected to heavy loads, especially in high temperature environments. Furthermore, it needs to be easy to produce in order to be profitable on the market. Therefore, the manufacturing process needs to be continuous and able to produce large products, such as for example strip substrates at least 100 meters long.

Consequently, the object of the present disclosure is to provide a metal substrate having non-stick properties which is cost effective to produce and suitable for use in even severe industrial environments, such as in manufacturing processes for electrical components or as surfaces in contact with low melting metals.

### SUMMARY

The above identified object has been accomplished by providing a non-stick product comprising a metal substrate with at least one coating layer essentially consisting of a substantially hydrophobic metal oxide having an amorphous structure. The metal oxide of the coating layer is preferably selected from a group consisting of oxides based on Ti, Al, Si, Cr, and/or Zr. The coating layer is preferably very thin, i.e. maximally 500 nm, and produced by PVD-technique in order to get a thin evenly distributed layer. The adhesion of the coating layer to the substrate is extremely good, wherein the substrate can be bent at least 90°, usually 180°, over a radius equal to the thickness thereof without the coating layer spalling or flaking of.

The non-stick metal product is suitable for use in manufacturing processes for electrical components, such as capacitors or batteries, or as surfaces in contact with low temperature melting metals.

### BRIEF DESCRIPTION OF THE FIGURES

FIG. 1 Metal substrate in the form of a strip, plate or bar comprising a coating

FIG. 2 Metal substrate in the form of a tube comprising a coating

FIG. 3 Wetting angle of a hydrophilic respectively a hydrophobic surface

FIG. 4 Example of a possible coating method

FIG. 5 Non-stick metal product according to the present disclosure as supporting intermediate strip.

### DETAILED DESCRIPTION

The non-stick metal product and the method of producing such a metal product will now be described in more detail with aid of the figures. These figures should not be considered to be limiting to the invention but illustrating specific examples thereof. It should be emphasized that the scale of the figures are not the actual scale since some features have been scaled up in order to illustrate the present disclosure in a more clear manner.

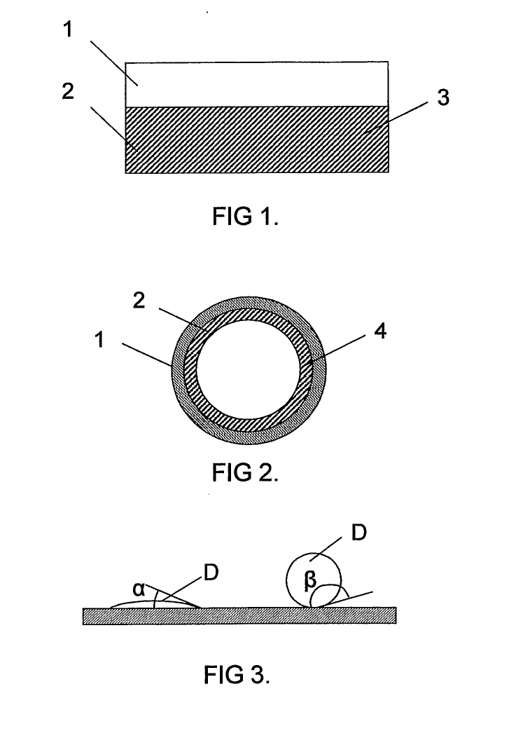

The non-stick metal product according to the present disclosure consists of a substrate 2 and at least one substantially hydrophobic amorphous coating layer 1 having non-stick properties, as illustrated in FIGS. 1 and 2. In this context “substantially hydrophobic” is considered to mean having a wetting angle with water at least 60°, preferably at least 90°. Even though it is possible to have an intermediate bonding layer, the non-stick coating is preferably, due to mainly economical reasons, in direct contact with the underlying substrate. The non-stick coating is in all cases the outermost coating on the substrate. The non-stick metal product experience superior adhesion to the substrate, which makes it possible to bend it at least 90°, usually also 180°, over a radius equal to the thickness of the metal product without the coating showing any tendency of flaking or the like. The superior adhesion of the coating to the substrate allows the metal product be processed to the intended final shape by conventional forming methods, such as stamping, slitting or cutting.

The non-stick coating layer of the product comprises at least one metal oxide MeₓO_{y}, wherein Me is at least one metal, and preferably y≧x. According to an embodiment Me is selected from a group consisting of Ti, Al, Si, Cr, and/or Zr. The metal oxide has a substantially amorphous microstructure. Preferably, in the case Me is selected from Ti, Zr and/or Si, y≧2x; and in the case Me is selected from Al and/or Cr, y≧1.5x.

Optionally, the coating may also contain additions, such as elements or compounds that stabilize the coating or the surface of the coating further. Stabilizing should in this context be considered in its broadest sense and consequently include additions for e.g. stabilizing the amorphous microstructure, improve the corrosion resistance of the coating and/or protect the coating against UV-radiation. The addition may be added to the coating during the deposition process, or after the process, by for example treating the surface with a solution containing the addition.

For example, in the case the metal oxide is TiₓO_{y}, such as TiO₂, the stabilizing addition may be Si, or Si containing compounds, such as SiOₓ (wherein x is 1-2) or siloxanes. These specific additions result inter alia in a more fingerprint-resistant coating and a stabilization of the structure of the TiₓO_{y}.

The thickness of the non-stick coating is generally adapted to the intended final product. However, it is preferably as small as possible, mainly for economical reasons. According to one embodiment of the present disclosure, the thickness of the non-stick coating is maximally 500 nm, preferably max 250 nm, more preferably max 150 nm, most preferably max 100 nm.

According to another embodiment the metal oxide of the coating layer has a substantially stoichiometric composition, which leads to a lower susceptibility of attracting elements and/or components which may react with the surface atoms of the coating. Hence, a stoichiometric composition improves the non-stick properties of the coating.

According to another embodiment the metal oxide has an oxygen-over stoichiometric composition. In this case, the excess of the oxygen is substitutionally or interstitially solved in the composition, which to a higher degree ensures that the surface of the composition in reality has a stoichiometric composition.

Another property that affects the non-stick properties is the surface potential. Therefore, according to one embodiment, the substance that should not stick to the product, and the surface of the product, should have potentials which are as close as possible to each other.

The substrate according to the present disclosure is metallic. It may be in any geometrical form suitable for the intended final product. For example, if the final product is a transporting belt, the substrate preferably has the form of a strip 3 as illustrated in FIG. 1, or in the case the final product is a supporting roller for winding of plastic sheets, the substrate is preferably in the form of a tube 4 as illustrated in FIG. 2. The substrate may also be perforated for example in order to allow hot air to pass through the substrate, if needed in the intended application/environment. Suitable thicknesses of the substrate usually fall within the range of 0.1 mm to 5 mm, however also thicker substrates may be utilized.

Preferably the substrate consists of Fe, Al, Cu, Ni or an alloy based on any of these elements. If the final product needs to have substantial mechanical strength, for example when used as support during industrial manufacturing processes, it is especially advantageous to utilize carbon steel or stainless steel as substrate. A stainless steel is also highly suitable at elevated temperatures for example as transporting belts passing through furnaces, due to a low risk of distortion of the substrate.

According to a preferred embodiment in the case when the non-stick product is to be used in elevated-temperature manufacturing processes for electrical components such as capacitors or batteries, it is preferred that the substrate has a low thermal expansion so as to not cause damage of the electrical component due to expansion of the non-stick product. In this context, a low thermal expansion is considered to be 10 nm/m° C. or less at 250° C.

More specifically, it is preferred to utilize a substrate made of an alloy essentially consisting of 60-70% Fe and 30-40% Ni; such as UNS K93600, which has an expansion of approximately 3 μm/m° C. at 250° C.

The metal oxide coating can be produced by any conventional coating method resulting in an amorphous coating. However, by utilizing PVD, a process which is relatively fast and performed at a relatively low substrate temperature may be accomplished. Due to the low temperature of the PVD process the diffusivity of the elements of the coating is suppressed whereby the elements are less likely to form crystalline phases. Furthermore, by utilizing PVD a very thin uniform coating having superior adhesion may be produced, as described above.

According to an embodiment of the invention the coating is produced in a continuous PVD process, whereby non-stick coated substrates in lengths up to at least 20 km may be produced without having to be welded together to the final length. Also, if desired the coated substrate may be cut into shorter pieces which render a much lower manufacturing cost of the intended final product, compared to batch processes.

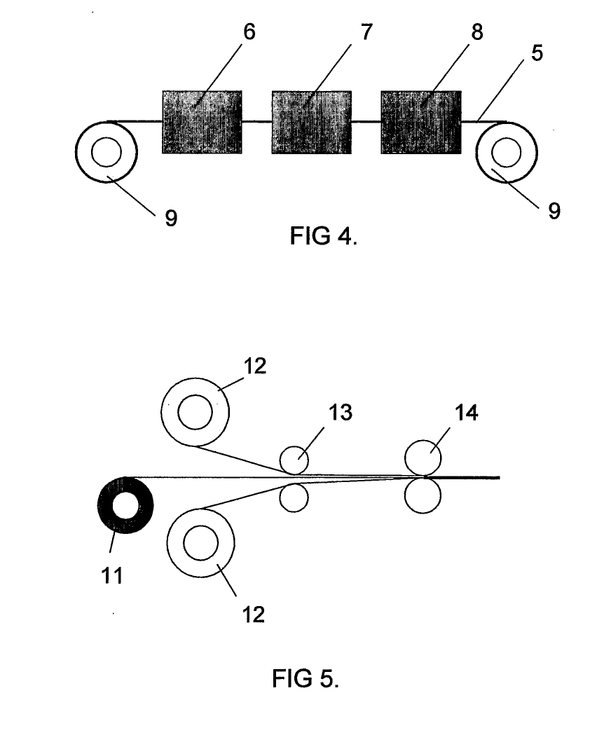

The continuous PVD process is illustrated in FIG. 4. The substrate 5 is allowed to pass from between two rollers 9 through at least one optional pretreatment chamber 6, such as a chamber for removal of oil residues and/or a native oxide layer on the surface of the substrate, at least one deposition chamber 7, and at least one optional chamber for after-treatment 8, such as an additional surface treatment with a stabilizing agent as described earlier. When the coating is produced in a continuous PVD process, the substrate is preferably in the form of a strip or wire since it has to be able to coil on the rollers 9. Suitable thickness of the substrate in this type of process is usually 3 mm or less.

One example of a suitable PVD-process to be used in the present application is electron beam (EB) evaporation. The main advantage of using EB evaporation is that it is a fast process compared to for example CVD or sputtering, since the coating may be performed at a rate which is at least 100 times higher than a fast CVD process. It is also a process wherein it is fairly easy to control the process so as to produce an amorphous coating. Also, since the process is very fast the time for which the substrate is subjected to an elevated temperature is relatively low. This facilitates the accomplishment of an amorphous coating and minimizes the risk of deteriorating the properties of the substrate, like tensile strength, planarity and geometrical dimension. Furthermore, compared to other processes it is relatively easy to accomplish a low tolerance in variation of the coating thickness even on large scale substrates, such as for example one kilometer long substrates.

The metal product having non-stick properties according to the present disclosure may suitably be utilized as supporting or spacing plates/strips in industrial manufacturing processes requiring mechanical strength, such as during pressing, clamping or the like of relatively soft materials like polymer based materials. One such example is in the production of film chip capacitors. FIG. 5 illustrates an example wherein the non-stick metal product serves as a supporting strip located between two soft materials, for example metallized polymers, in the form of belts which should be rolled down to a smaller thickness. The belts are introduced on coilers 12 and the non-stick product is located on another coiler 11. A pair of guiding rollers 13 ensure that the belts which should be rolled together is guided into a pair of rollers 14 used to reduce the size of the soft materials.

Furthermore, the non-stick metal product could also be used in the manufacturing process of thin foils of low-melting metals, for example as rollers for rolling of lithium foils for batteries. Also, other devices, such as bobbins and intermediate plates, in the manufacturing process of lithium batteries may utilize this non-stick metal product.

Yet further applications may be funnels for oils or other liquid substances; moulds for casting objects of low temperature melting metals, such as tin soldiers; stiffening substrates during processing of polymers, e.g. during rolling; in manufacturing processes for electrical components such as capacitors or batteries.

### EXAMPLE 1

A strip substrate having the following approximate composition: 0.68 wt-% C, 13 wt-% Cr, 0.4 wt-% Si and 0.6 wt-% Mn with a tensile strength of 1070 MPa, was coated with a layer of substantially stoichimetric TiO₂ by EB-evaporation PVD in a continuous process. The thickness of the strip was 0.10 mm and the thickness of the TiO₂ was approximately 60 nm. The microstructure of TiO₂ showed no crystalline phases when analyzed with X-ray diffraction. The wetting angle of water against the surface was in the range 71-75°.

The non-stick coated metal product was subjected to a bending test according to standard SS-EN ISO 7438, wherein the strip was bent 180° over a radius equal to the thickness of the substrate, i.e. 0.10 mm. The TiO₂ showed no tendency of flaking or the like.

The non-stick coated metal product was successfully used as intermediate support strip during heating to a temperature of about 200-220° C. in the manufacture of capacitors from metallized PET film. The non-stick substrate provided a good mechanical strength for this application and showed no tendency of the metallized PET film sticking to the surface of the non-stick coated metal product. Furthermore, the non-stick coated metal product was produced in a more economical manner than traditionally used materials for this application.

### EXAMPLE 2

A strip substrate having the following approximate composition: 0.09 wt-% C, 16.3 wt-% Cr, 1.15 wt-% Si, 7.3 wt-% Ni, 0.7 wt-% Mo and 1.25 wt-% Mn with a tensile strength of 2180 MPa, was provided with a layer of substantially stoichimetric Al₂O₃. The thickness of the strip was 0.10 mm and the thickness of the Al₂O₃ was approximately 50 nm. The microstructure showed no crystalline phases when analyzed with X-ray diffraction. The wetting angle of water against the surface was in the range 85-90°.

The coated strip substrate is believed to be highly suitable for use at elevated temperatures, especially under reducing atmosphere. It may also successfully be used in the manufacturing process of chip film capacitors.

### EXAMPLE 3

The non-stick product of Example 1 was produced with the only difference in the selection of the substrate. In this case a strip substrate of UNS K93600 was used. The non-stick coated metal product was used as intermediate support strip during heating to a temperature of about 250° C. in the manufacture of capacitors from metallized PET film. Compared to the non-stick product of Example 1 the utilization of a substrate with low expansion proved to eliminate the risk of damaging the produced component at the higher production temperature of 250° C.

1. Supporting strip in an industrial manufacturing process for electrical components consisting of a non-stick metal product comprising a metal substrate and at least one coating layer that wherein the coating layer is the outer-most coating layer on the substrate and essentially consists of a substantially hydrophobic metal oxide having an amorphous microstructure, wherein the substrate can be bent at least 90° over a radius equal to the thickness of thereof without the coating layer spalling or flaking.

2. Supporting strip according to claim 1, wherein the coating layer is up to 500 nm thick.

3. Supporting strip according to claim 1, wherein the metal of the metal oxide is selected from Ti, Al, Si, Cr, and/or Zr.

4. Supporting strip according to claim 3, wherein the metal oxide essentially consists of TiO₂.

5. Supporting strip according to claim 4, wherein the TiO₂ optionally is stabilized by Si or a Si containing compound, such as SiO₂ or a siloxane.

6. Supporting strip according to claim 1, wherein the metal substrate is made of a carbon steel or a stainless steel.

7. Supporting strip according to claim 1, wherein characterized in that the metal substrate is an alloy with a thermal expansion of 10 μm/m° C. or less at 250° C.

8. Supporting strip according to claim 1, wherein characterized in that the metal substrate essentially consists of 60-70% Fe and 30-40% Ni.

9. Spacing plate in an industrial manufacturing process consisting of a non-stick metal product comprising a metal substrate and at least one coating layer wherein the coating layer is the outermost coating layer on the substrate and essentially consists of a substantially hydrophobic metal oxide having an amorphous microstructure, wherein the substrate can be bent at least 90% over a radius equal to the thickness of thereof without the coating layer spalling or flaking.

10. Spacing plate according to claim 9, wherein the coating layer is up to 500 nm thick.

11. Spacing plate according to claim 9, wherein the metal of the metal oxide is selected from Ti, Al, Si, Cr, and/or Zr.

12. Spacing plate according to claim 11, wherein the metal oxide essentially consists of TiO₂.

13. Spacing plate according to claim 12, wherein the TiO₂ optionally is stabilized by Si or a Si containing compound, such as SiO₂ or a siloxane.

14. Spacing plate according to claim 9, wherein the metal substrate is made of a carbon steel or a stainless steel.

15. Spacing plate according to claim 9, wherein the metal substrate is an alloy with a thermal expansion of 10 μm/m° C. or less at 250° C.

16. Spacing plate according to claim 9, wherein the metal substrate essentially consists of 60-70% Fe and 30-40% Ni.

17. Stiffening substrate during processing of polymeric material, said substrate consisting of a non-stick metal product comprising a metal substrate and at least one coating layer wherein the coating layer is the outermost coating layer on the substrate and essentially consists of a substantially hydrophobic metal oxide having an amorphous microstructure, wherein the substrate can be bent at least 90% over a radius equal to the thickness of thereof without the coating layer spalling or flaking.

18. Bobbin for carrying Li-metal foil in the manufacturing process of lithium batteries consisting of a non-stick metal product comprising a metal substrate and at least one coating layer wherein the coating layer is the outer-most coating layer on the substrate and essentially consists of a substantially hydrophobic metal oxide having an amorphous microstructure, wherein the substrate can be bent at least 90% over a radius equal to the thickness of thereof without the coating layer spalling or flaking.

19. Roller for rolling of lithium foils for batteries consisting of a non-stick metal product comprising a metal substrate and at least one coating layer wherein the coating layer is the outermost coating layer on the substrate and essentially consists of a substantially hydrophobic metal oxide having an amorphous microstructure, wherein the substrate can be bent at least 90% over a radius equal to the thick-ness of thereof without the coating layer spalling or flaking.
